(19) United States
(12) Patent Application Publication
(10) Pub. No.: US 2013/0192632 A1
(43) Pub. Date: Aug. 1, 2013

(54) CLEANER FOR THE HULLS OF BOATS OR SHIPS

(71) Applicant: RANIERO CAZZANIGA, PISA (IT)

(72) Inventor: RANIERO CAZZANIGA, PISA (IT)

(21) Appl. No.: 13/359,782

(22) Filed: Jan. 27, 2012

(51) Int. Cl. B08B 1/00; B63B 59/06

(52) U.S. Cl. 134/6; 114/222

(57) ABSTRACT

A cleaner for the hulls of boats or ships comprises a supporting frame (2), at least one cleaning element (5) associated with the frame (2) and which can be positioned opposite a surface (4) to be cleaned, hold-down means (7) connected to the frame (2) and acting between the frame (2) and the surface (4) to be cleaned, for keeping the cleaner in contact with the surface to be cleaned, and movement means (13) associated with the frame (2) for moving, in conjunction with the hold-down means (7), the frame (2) along the surface (4) to be cleaned.

### BACKGROUND OF THE INVENTION

This invention relates to a cleaner for the hulls of boats or ships.

This invention is applied in the nautical field and, more precisely, in the maintenance of vessels.

One of the problems which must be faced in order to carry out thorough maintenance of a boat (or a ship) is that of cleaning the hull, that is to say, the part of the craft which is usually immersed in the water.

In fact, the long period of time for which that part of the boat is immersed in water results in the build up of dirt and deposits which compromise the integrity and the performance of the boat.

Consequently, regular cleaning of the hull is required to keep the boat operating at optimum levels.

In the prior art that operation is carried out by dry-docking the boat on a dedicated dock and performing the cleaning with suitable machines or, alternatively personnel.

Alternatively, especially for large ships whose dry-docking would be quite complex, a team of divers carries out underwater cleaning of the hull.

Disadvantageously, said procedures are quite complex and expensive, since they require suitable and large equipment for lifting the boat or specialist personnel.

To overcome said disadvantages, patent document DE 4443310 A1 proposes a cleaning robot for the hulls or boats or ships, equipped with a pair of frames (quadrilaterals) which are connected to each other and can move relative to one another along two lines which are perpendicular to each other, and a nozzle designed to produce a concentrated jet of water on the hull of the boat to clean it.

Each of the frames is provided with suction cups positioned at the vertices of the quadrilateral for gripping the surface to be cleaned.

It should be noticed that the suction cups of one frame can be activated and moved independently of the suction cups of the other frame, in such a way as to allow the robot to be fed along the hull of the boat.

A movement similar to that just described is known from document WO 84/04733. However, in that document the suction cups are substituted by electromagnets.

Disadvantageously, said solutions provide cleaners which are not very versatile and have poor agility, since they only move (with each step) along straight trajectories.

Also, the stiffness of the connection between the suction cup/electromagnet and the frame makes it difficult, if not impossible, for the robot to be fed where there are accentuated changes in the gradient.

Document DE 29822221 U1 shows a robot having a frame similar to the previous ones, but able to move on a surface by means of rotation of the suction cups (or electromagnets) about axes of rotation which are perpendicular to the surface itself.

Disadvantageously, that produces sliding of the suction cups or electromagnets on the surface, which causes both wear on them and difficulty getting past obstacles.

A further solution is shown in document US 2010/0126403 A1, which describes a cleaning robot equipped with a turbine, which can be activated for keeping the robot in contact with the hull, track means for allowing robot feed along the hull and a plurality of rotary brushes for cleaning the hull.

A similar device (equipped with units for generating a vacuum for keeping the cleaner in contact with the surface to be cleaned and tracks or wheels for moving along the surface) is described in document WO 03/022532.

Disadvantageously, such robots are derived from “pool washing” robots and have the disadvantages typical of them, including poor grip on the surface to be cleaned, especially if it is vertical.

In fact, such solutions involve moving the robot during operation of the vacuum generating units (or the turbines), which out of necessity cannot guarantee an excessive grip.

### SUMMARY OF THE INVENTION

In this context, the technical purpose which forms the basis of this invention is to provide a cleaner for the hulls of boats or ships which overcomes the above-mentioned disadvantages of the prior art.

In particular, this invention has for an aim to provide a cleaner for the hulls or boats or ships which can operate under water.

A further aim of this invention is to provide a cleaner for the hulls of boats or ships which is economical and easy to use.

The technical purpose indicated and the aims specified are achieved by a cleaner for the hulls of boats or ships comprising the technical features described in one or more of the appended claims.

The cleaner according to the invention is a self-propelled device equipped with gripping units for adhering to the wall of the hull to be cleaned, movement means, for moving along the wall and a cleaning element acting on the zone of the surface to be cleaned which is opposite the device.

In particular, the cleaner according to the invention comprises:

a supporting frame;

at least one cleaning element associated with the frame and which can be positioned opposite a surface of the hull to be cleaned;

hold-down means connected to the frame and acting between the frame and the surface to be cleaned, for keeping the cleaner in contact with the surface to be cleaned;

movement means associated with the frame for moving, in conjunction with the hold-down means, the frame along the surface to be cleaned.

According to the invention, the movement means comprise a plurality of articulated legs, each comprising a first portion associated with a respective hold-down unit and a second portion associated with the frame; the first and second portions pivoting at each other in such a way that they can rotate one relative to the other about an axis which is substantially parallel with the surface to be cleaned, in such a way that each hold-down unit can be lowered and raised relative to the surface to be cleaned.

Preferably, the second portion comprises a first end pivoting at the first portion, in such a way as to allow rotation about the axis, and a second end pivoting at the frame in such a way as to allow rotation about a further axis which is operatively positioned perpendicular to the surface to be cleaned.

Moreover, the movement means comprise independent drive units for moving the first portions of the legs relative to the second portions and for moving the second portions of the legs relative to the frame.

Preferably, the second portion of each leg comprises a first sub-part and a second sub-part which pivot at one another in such a way that they can rotate one relative to the other about an axis which is substantially parallel with the surface to be cleaned.

The first sub-part pivoting at the frame and the second sub-part pivoting at the first portion of the leg.

Preferably, the movement means comprise at least four articulated legs which are able to move independently of each other.

The hold-down means comprise a first and a second gripping unit, which are separate and each of which can be selectively switched between an active configuration, in which they keep the cleaner in contact with the surface to be cleaned, and an inactive configuration. The first gripping unit, in the active configuration, also being able to move relative to the frame, for allowing movement of the frame along a line of feed.

Preferably, at least one of the gripping units comprises two ends positioned along an axis which is perpendicular to the line of movement of the gripping unit relative to the frame, in such a way as to act simultaneously on separate portions of the surface to be cleaned.

For example, said ends are formed by two suction cups associated with corresponding arms.

More preferably, each of the gripping units comprises two ends positioned along an axis which is perpendicular to the line of movement of the gripping unit relative to the frame, in such a way as to act simultaneously on separate portions of the surface to be cleaned, said axes being positioned transversally relative to each other.

That allows particular stability in the grip of the cleaner on the surface, even during its movement.

It should be noticed that the invention also provides a method for cleaning a hull of a boat or a ship.

According to the invention, the method comprises the following steps:

a) preparing a device comprising a supporting frame, at least one cleaning element associated with the frame and which can be positioned opposite a surface of the hull to be cleaned, hold-down means which are connected to the frame, acting between the frame and the surface to be cleaned, keeping the cleaner in contact with the surface to be cleaned and comprising a first and a second gripping unit which can be switched between an active configuration, in which they keep the cleaner in contact with the surface to be cleaned, and an inactive configuration, in which they are free to move relative to the surface to be cleaned; and movement means associated with the frame for moving, in conjunction with the hold-down means, the frame along the surface to be cleaned and comprising a plurality of articulated legs;

b) associating the device with the surface to be cleaned by activating at least the first gripping unit, thus allowing the cleaning element to clean a portion of the surface opposite it;

c) deactivating the second gripping unit;

d) lifting the second gripping unit by means of a rotation of the first portion of the respective leg about the axis;

e) moving the second gripping unit relative to the frame along a line of feed and in a predetermined direction, by means of a rotation of the respective leg about a further axis which is at a right angle to the surface to be cleaned, while the first gripping unit is in the active configuration;

f) activating the second gripping unit;

g) deactivating the first gripping unit;

h) lifting the first gripping unit by means of a rotation of the first portion of the respective leg about the axis;

i) moving the first gripping unit and the frame relative to the second gripping unit along the line of feed, in said predetermined direction, by means of a rotation of the leg of the second gripping unit about the further axis, while the second gripping unit is in the active configuration;

j) repeating the previous steps, starting with deactivating the second gripping unit, for moving the device along the line of feed.

That gives the cleaner two degrees of freedom in its movement, allowing the cleaner to brush the entire surface to be cleaned.

It should be noticed that, to assign the cleaner a second degree of freedom of movement, in addition or alternatively the method comprises a step of rotation of a first sub-part of the second portion of the leg, during the step of lifting the respective gripping unit so as to keep the gripping unit at a right angle to the surface to be cleaned.

Obviously, the reference to the first and second gripping unit is completely arbitrary, since their roles may be reversed.

### BRIEF DESCRIPTION OF THE DRAWINGS

Further features and advantages of this invention are more apparent in the non-limiting description which follows of a preferred non-limiting embodiment of a cleaner for the hulls of boats or ships illustrated in the accompanying drawings, in which:

FIG. 1 is a schematic view of a cleaner for the hulls of boats or ships according to this invention during use;

FIG. 2 is a partly exploded perspective view of a first embodiment of the cleaner of FIG. 1;

FIG. 3 is a bottom view of the cleaner of FIG. 2;

FIG. 4 is a top view of the cleaner of FIG. 2 with some parts cut away to better illustrate others;

FIGS. 5a to 5f are schematic views of the cleaner of FIG. 2 in a sequence of operating positions which it adopts during movement;

FIG. 6 is a schematic view of a cleaner according to this invention.

### DESCRIPTION OF THE PREFERRED EMBODIMENTS

With reference to the accompanying drawings, the numeral 1 denotes a cleaner for the hulls of boats, that is to say vessels or boats or ships, according to this invention.

The cleaner 1 can be applied to a surface 4 to be cleaned, preferably the hull of a boat or a ship 35.

The cleaner 1 comprises a supporting frame 2 and, preferably, a casing 36 covering the frame 2.

The frame 2 comprises a base 3 which can be positioned opposite the surface 4 to be cleaned.

In the embodiment illustrated, the base 3 is a polygonal plate, preferably quadrilateral.

In other embodiments, the base may adopt different shapes or may have a reticular structure.

In particular, the base 3 comprises a first face 3a, which can be positioned opposite the surface 4 to be cleaned, and a second face 3b, which is opposite to the first 3a.

Connected to the frame 2 there is a cleaning element 5 which can be positioned opposite the surface 4 to be cleaned, for eliminating any dirt caked on it.

More precisely, the cleaning element 5 is externally opposite the base 3 of the frame 2.

In other words, the cleaning element 5 projects outside the first face 3a of the base 3.

Preferably, the cleaning element 5 comprises at least one brush 6 which rotates relative to the base 3 about its own axis of rotation, preferably transversal to the base 3.

Advantageously, the presence of a rotary brush 6 allows efficient removal of the most stubborn dirt.

Preferably, the brush 6 is in a central zone of the base 3.

However, in other embodiments (not illustrated) it is possible that two or more rotary brushes are used simultaneously, for improved and even better distributed and more rapid cleaning.

By way of example, the brushes may be positioned at the vertices of the base, directly connected to it.

Alternatively, the brushes may be connected to the base by arms which project from it and which can preferably rotate relative to the base so as to increase the operating surface area of the cleaner 1.

In other embodiments, the cleaning element comprises rollers or units for generating a high pressure jet.

The cleaner 1 also comprises hold-down means 7 connected to the frame 2 and acting between the frame 2 and the surface 4 to be cleaned, for keeping the cleaner 1 in contact with the surface 4 to be cleaned.

More precisely, the hold-down means 7 can be activated to prevent detachment between the frame 2 and the surface 4, in such a way that the cleaner 1 operates correctly.

In other words, the hold-down means 7 allow the cleaner 1 to generate high friction forces between the cleaning element 5 and the surface 4 to be cleaned.

Preferably, the hold-down means 7 comprise one or more gripping units 8a, 8b which generate an attractive force between the surface 4 and the frame 2.

Each of the gripping units 8a, 8b can be selectively activated for making contact with the surface 4.

Preferably, the cleaner comprises a plurality of gripping units 8a, 8b.

In the embodiment illustrated, the cleaner 1 comprises a first gripping unit 8a and a second gripping unit 8b.

Preferably, said gripping units 8a, 8b operate separately from each other.

In other words, the gripping units 8a, 8b can be activated and deactivated independently of one another.

The advantage given by that independence is clearer below.

Preferably, each gripping unit 8a, 8b can be selectively switched between an active configuration, in which it remains connected to the surface 4, and an inactive configuration, in which it does not oppose detachment from the surface 4.

It is important to emphasize that, in the active configuration, each gripping unit 8a, 8b is stationary relative to the surface 4 to be cleaned.

Moreover, when the gripping units 8a, 8b are in the active configuration they keep the cleaning element 5 operatively associated with, and preferably in contact with, the surface 4 to be cleaned.

For example, the gripping unit 8a, 8b may be of the “vacuum” type or magnetic.

In the embodiment illustrated, the gripping units 8a, 8b are of the “vacuum” type.

With regard to that, each gripping unit 8a, 8b comprises at least one suction device 9a, 9b.

Advantageously, that allows correct operation of the cleaner 1 irrespective of the material of the hull 35 to be cleaned.

Moreover, the use of suction devices 9a, 9b is optimum for underwater use of the cleaner 1.

In other embodiments (not illustrated), the gripping units 8a, 8b comprise magnetic devices in place of the suction devices.

Preferably, the first gripping unit 8a and the second gripping unit 8b each comprise at least one respective suction device 9a, 9b.

Each suction device 9a, 9b can be selectively switched between an operating configuration and a non-operating configuration, which respectively correspond to the active and inactive configurations of the respective gripping unit 8a, 8b.

Preferably, each gripping unit 8a, 8b comprises two respective suction devices 9a, 9b.

Moreover, preferably, the suction devices 9a, 9b of a single gripping unit 8a, 8b are operatively connected to each other.

In other words, the suction devices 9a, 9b of each gripping unit 8a, 8b can be simultaneously switched between the operating and the non-operating configurations.

In the embodiment illustrated, each suction device 9a, 9b comprises at least one suction cut 10 which can be positioned opposite the surface 4 to be cleaned so as to grip it.

Consequently, each suction cup 10 projects from the first face 3a of the base 3 of the frame 2 in the same way as the cleaning element 5 to the surface 4.

Moreover, the suction devices 9a, 9b each comprise a vacuum pump (not illustrated) associated with the suction cup 10 and which can be selectively activated for increasing the attractive force of the suction cup 10.

It should be noticed that activation or deactivation of each vacuum pump determines the operating or non-operating configuration of the respective suction device 9a, 9b.

In the preferred embodiment, the suction devices 9a, 9b of the same gripping unit 8a, 8b share a single vacuum pump associated with both suction cups 10.

Advantageously, that simplifies switching of the suction device 9a, 9b from the operating to the non-operating configuration.

Alternatively, each suction device may comprise a respective vacuum pump.

The cleaner 1 also comprises movement means 13 associated with the frame 2 for moving, in conjunction with the hold-down means 7, the frame 2 along the surface 4 to be cleaned.

In particular, the movement means 13 act between the frame 2 and the first gripping unit 8a, generating a relative movement along a line of feed “A” between the frame 2 and the first gripping unit 8a.

In other words, the first gripping unit 8a can move relative to the frame 2 along the line of feed “A”.

Preferably, the first gripping unit 8a and the second gripping unit 8b can be activated alternatively to allow the movement means 13 to move the frame 2 relative to the surface 4 along the line of feed “A”.

In particular, when the first gripping unit 8a is active and the second gripping unit 8b is inactive, the movement means 13, acting on the first gripping unit 8a, move the frame 2 relative to the surface 4 along the line of feed “A”.

In contrast, when the first gripping unit 8a is inactive and the second gripping unit 8b is active, the movement means 13 move the first gripping unit 8a relative to the surface 4 along the line of feed “A”.

In light of that, the fact that the first and second gripping units 8a, 8b are independent of each other is particularly advantageous.

Preferably, the movement means 13 comprise a drive unit 19, connected to the frame 2, and a movement unit 20 acting between the drive unit 19 and the first gripping unit 8a.

The movement unit 20 comprises at least one movement leg 11 extending transversally to the base 3, along its own line of extension “C”, between a first end 11a and a second end 11b, which is opposite to the first end 11a and associated with the first gripping unit 8a.

More precisely, connected to the second end 11b there is the suction cup 10 of the suction device 9a of the first gripping unit 8a.

The movement leg 11 extends at a right angle to the base 3 through the latter.

In other words, the line of extension “C” of the leg 11 is at a right angle to the base 3.

With regard to that, the base 3 comprises at least one through slot 3c in which the leg 11 can slide.

More precisely, the slot 3c is straight and extends parallel with the line of feed “A”.

Advantageously, the leg 11, whose movement is driven by the drive unit 19, slides rigidly inside the slot 3c along the line of feed “A”.

More precisely, the leg 11 slides along a line which is transversal, preferably at a right angle, to its own line of extension “C”.

The leg 11 conveys the respective suction cup 10 along the line of feed “A”.

Since, in the embodiment illustrated, the first gripping unit 8a comprises two suction devices 9a, the movement unit 20 comprises two legs 11, substantially parallel with each other and rigidly connected at the respective first end 11a.

In light of that, the base 3 comprises two straight slots 3c which are parallel with and opposite each other.

The slots 3c are positioned on opposite sides of the base 3, preferably in a substantially symmetrical fashion.

In this way, both legs 11 slide in a parallel fashion in the slots 3c along the line of feed “A”.

Preferably, the movement unit 20 comprises a crosspiece 15 which rigidly joins the two legs 11, preferably at the respective first ends 11a.

Consequently, the movement unit 20 at least partly comprises a substantially “gantry-style” structure.

In detail, the uprights of the gantry are formed by the legs 11 and the beam is formed by the crosspiece 15.

The suction cups 10 are at the “feet” of the uprights.

The movement means 13 also comprise a guide 16 rigidly connected to the frame 2 and extending along the line of feed “A”.

The guide 16 is slideably associated with the legs 11 for promoting their movement along the line of feed “A”.

More precisely, the movement unit 20 slides on the guide 16 by means of a carriage 28.

The carriage 28 is slideably constrained to the guide 16 and is connected to the movement unit 20.

In the embodiment illustrated, the movement means 13 comprise two guides 16 which are parallel with each other. The carriage 28 can slide on both of them.

Preferably, the movement unit 20 is slideably constrained to the carriage 28 along a line transversal to the base 3, even more preferably along the line of extension “C” of the legs 11.

In other words, the movement unit 20 can slide relative to the carriage 28 along a line parallel with the line of extension “C” of the legs 11, but it is fixed relative to the carriage along the line of feed

In the preferred embodiment, the carriage 28 is at least partly formed by a bar 28a extending parallel with the crosspiece 15.

More precisely, the bar 28a extends transversally to both of the guides 16 and rests on them.

Close to its ends, the bar 28a comprises two holes 28b in which the legs 11 of the movement unit 20 can slide transversally to the base 3.

In particular, making the legs 11 slide in the holes 28b, a movement of the crosspiece 15 towards and/or away from the carriage 28 is generated.

The function of that slideable constraint is more clearly explained below.

Preferably, the drive unit 19 is connected to the carriage 28 by means of a transmission device 17.

In the embodiment illustrated, the transmission device 17 comprises a crank mechanism 18, preferably of the connecting rod—crank type.

More precisely, a crank is rigidly connected to the drive unit 19 whilst a connecting rod is connected to the carriage 28.

In other embodiments (not illustrated), the drive unit comprises a pinion which can engage with the carriage, on which a rack is rigidly mounted.

In the embodiment illustrated, the movement means 13 comprise two drive units 19 each acting at a respective leg 11 of the movement unit 20.

More precisely, each drive unit 19 is connected to the carriage 28 close to a zone where the carriage is connected to a respective leg 11.

In other words, each drive unit 19 is connected to the bar 28a close to the holes 28b.

Advantageously, that allows the action of the drive unit 19 to be balanced, preventing stresses from being created on the structure.

Preferably, the movement means 13 also act between the frame 2 and the second gripping unit 8b, generating a relative movement along a further line of feed “B” between the frame 2 and the second gripping unit 8b.

In other words, the second gripping unit 8b can move relative to the frame 2 along the further line of feed “B”.

Preferably, that further line of feed “B” is transversal to the line of feed “A”.

Even more preferably, the further line of feed “B” is at a right angle to the line of feed “A”.

Advantageously, that simplifies and speeds up cleaning of the hull.

Similarly to what was previously said, when the first gripping unit 8a is inactive and the second gripping unit 8b is active, the movement means 13, acting on the second gripping unit 8b, move the frame 2 relative to the surface 4 along the further line of feed “B”.

In contrast, when the first gripping unit 8a is active and the second gripping unit 8b is inactive, the movement means 13 move the second gripping unit 8b relative to the surface 4 along the further line of feed “B”.

Preferably, the movement means 13 comprise a further drive unit 14, connected to the frame 2, and a further movement unit 21 acting between the further drive unit 14 and the second gripping unit 8b.

Even more preferably, the further movement unit 21 is similar to the movement unit 20, angled transversally relative to it for translating along the further line of feed “B”.

In other words, the further movement unit 21 comprises at least one movement leg 22 extending transversally to the base 3, along the line of extension “C”, between a first end 22a and a second end 22b, which is opposite to the first end 22a and associated with the second gripping unit 8b.

More precisely, connected to the second end 22b there is a suction cup 10 of the second suction device 9b.

Similarly to what was described above, the movement leg 22 extends at a right angle to the base 3 through the latter.

With regard to that, the base 3 comprises at least one further longitudinal slot 3d, extending along the further line of feed “B”, in which the leg 22 can slide.

Advantageously, the leg 22, whose movement is driven by the respective further drive unit 14, slides rigidly inside the further slot 3d along the further line of feed “B”.

The leg 22 therefore conveys the respective suction cup 10 along the further line of feed “B”.

Since, in the embodiment illustrated, the second gripping unit 8b comprises two suction devices 9b, the movement unit 21 comprises two legs 22, substantially parallel with each other and rigidly connected at the respective first end 22a.

Said legs 22 each slide in a respective further slot 3d which is angled along the further line of feed “B”.

In light of that, the base 3 comprises four slots 3c, 3d in parallel pairs. The pair of slots 3c is at a right angle to the pair of further slots 3d.

Preferably, the two pairs of slots 3c and 3d are arranged along the sides of a parallelogram (preferably a rectangle or a square). Preferably, the two pairs of slots 3c and 3d are arranged in a central position (at the centre line) of said sides.

That optimizes the capacity for movement of the cleaner and its stability during movement.

Preferably, the further movement unit 21 comprises a crosspiece 23 which rigidly joins the two legs 22.

Consequently, the further movement unit 21, like the movement unit 20, at least partly comprises a substantially “gantry-style” structure.

In detail, the uprights of the gantry are formed by the legs 22 and the beam is formed by the crosspiece 23.

The suction cups 10 are at the “feet” of the uprights.

The movement means 13 also comprise a further guide 24 rigidly connected to the frame 2 and extending along the further line of feed “B”.

In other words, the further guide 24 is at a right angle to the guide 16.

The further guide 24 is slideably associated with the legs 22 of the further movement unit 21 for promoting the movement of the legs 22 along the further line of feed “B”.

More precisely, the further movement unit 21 slides on the further guide 24 by means of a respective carriage 26.

The carriage 26 is slideably constrained to the further guide 24 and is connected to the further movement unit 21.

In the embodiment illustrated, the movement means 13 comprise two further guides 24 which are parallel with each other, both slideably connected to the respective carriage 26.

Preferably, the further movement unit 21 is slideably constrained to the carriage 26 along a line transversal to the base 3, even more preferably along the line of extension “C” of the legs 22.

In other words, the further movement unit 21 can slide relative to the carriage 26 along a line parallel with the line of extension “C” of the legs 22, but it is fixed relative to the carriage along the further line of feed “B”.

In the preferred embodiment, the carriage 26 is at least partly formed by a bar 26a extending parallel with the crosspiece 23.

More precisely, the bar 26a extends transversally to both of the further guides 24 and rests on them.

Close to its ends, the bar 26a comprises two holes 26b in which the legs 22 of the further movement unit 21 can slide transversally to the base 3.

In particular, making the legs 22 slide in the holes 26b, a movement of the crosspiece 23 towards and/or away from the carriage 26 is generated.

Preferably, the further drive unit 14 is connected to the carriage 26 by means of a respective transmission device 27.

In the embodiment illustrated, the transmission device 27 comprises a crank mechanism 29, preferably of the connecting rod—crank type.

More precisely, a crank is rigidly connected to the further drive unit 14 whilst a connecting rod is connected to the carriage 26.

In other embodiments (not illustrated), the further drive unit comprises a pinion which can engage with the respective carriage, on which a rack is rigidly mounted.

In the embodiment illustrated, the movement means 13 comprise two further drive units 14 acting at a respective leg 22 of the further movement unit 21.

More precisely, each further drive unit 14 is connected to the respective carriage 26 close to a zone where the carriage is connected to a respective leg 22.

In other words, each further drive unit 14 is connected to the bar 26a close to the holes 26b.

Advantageously, that allows the action of the further drive unit 14 to be balanced, preventing stresses from being created on the structure.

To achieve improved cleaner 1 stability, the movement unit 20 and the further movement unit 21 are substantially arranged in a “cross” shape.

In other words, the two “gantry-style” structures are crossed and offset by around 90°.

More precisely, the crosspiece 15 of the movement unit 20 is at a right angle and crossed relative to the crosspiece 23 of the further movement unit 21.

Moreover, preferably, each gripping unit 8a, 8b can move towards and/or away from the surface 4 to be cleaned, between a contact position, in which it adheres to the surface 4, and a detached position, in which it is distal from the surface 4.

In other words, each suction device 9a, 9b is at least partly selectively mobile along a line which is transversal, preferably at a right angle, to the base 3 of the frame 2 between the above-mentioned contact and detached positions.

Advantageously, that facilitates movement of the cleaner 1 along the hull even if the hull has irregularities or protuberances.

With regard to that, the cleaner 1 comprises a first lifting unit 30a connected to the first gripping unit 8a and a second lifting unit 30b connected to the second gripping unit 8b.

The first lifting unit 30a and the second lifting unit 30b can be activated independently of each other to facilitate movement of the cleaner 1.

More specifically, the lifting units 30a, 30b are connected to the movement units 20, 21 for detaching or pressing the suctions cups 10 from or on the surface 4 to be cleaned.

In the embodiment illustrated, each lifting unit 30a, 30b acts between the crosspiece 15, 23 of the respective movement unit 20, 21 and the respective carriage 26, 28.

In light of that, the preparation of a sliding constraint between the carriages 26, 28 and the movement units 20, 21 is clearer.

More precisely, the lifting units 30a, 30b are mounted in such a way that they are fixed to each carriage 26, 28 and they act on the crosspiece 15, 23 of the respective movement unit 20, 21 in such a way as to move them towards and/or away from each other.

In the embodiment illustrated, the lifting units 30a, 30b are of the connecting rod—crank type, similarly to the drive units 14, 19.

In other embodiments (not illustrated), the lifting units may be of the cam, pneumatic or hydraulic type.

Preferably, the cleaner 1 comprises a control unit 31 associated with the gripping units 8a, 8b and with the movement means 13 for defining a feed path for the frame 2 along the surface 4 to be cleaned.

In particular, the movement of the cleaner 1 along the surface 4 to be cleaned is in separate steps and extends as follows.

For a simple description, the procedure for performing a single step along the line of feed “A” is described.

Obviously, the procedure is repeated over and over in order to move along the surface 4.

It should be noticed that the procedure is the same regarding movement along the further line of feed “B”.

To aid understanding, a starting configuration is established, in which all of the gripping units 8a, 8b are in the active configuration.

In other words, in the starting configuration all of the suction devices 9a, 9b are in the operating configuration.

That is to say, the vacuum pumps 12 are active and the suction cups 10 are in contact with the surface 4 to be cleaned.

At this point, the control unit 31 switches the first gripping unit 8a from the active configuration to the inactive configuration.

In other words, the vacuum pump of the suction devices 9a of the first gripping unit 8a is deactivated and the latter is brought to the detached position, that is to say, its suction cups 10 are raised off the surface 4 by the respective lifting unit 30a.

It should be noticed that the cleaner 1 continues gripping the surface 4 thanks to the second gripping unit 8b, which remains in the active configuration.

Then, the control unit 31 activates the movement means 13 which move the suction devices 9a, which are raised above the surface 4, along the line of feed “A”.

In particular, the drive unit 19 is activated and acts on the carriage 28, moving the movement unit 20 along the guide 16.

Once the carriage 28 reaches a predetermined position along the guide 16, the drive unit 19 is deactivated.

At this point, the control unit 31 returns the first gripping unit 8a to the active configuration.

In other words, the suction cups 10 of its suction devices 9a are moved into the contact position by the lifting unit 30a and the vacuum pump is activated.

It should be noticed that in this configuration the cleaner 1 is in a configuration like the starting configuration, the only substantial difference being the position of the suction devices 9a of the first gripping unit 8a, which have been fed along the line of feed “A”.

Then, the second gripping unit 8b is brought to the inactive configuration by the control unit 31.

Consequently, the vacuum pump of its suction devices 9b is deactivated and they are brought to the detached position, that is to say, their suction cups 10 are raised off the surface 4 by the respective lifting unit 30b.

After that, the control unit 31 reactivates the movement means 13.

In this case, since the first gripping unit 8a is constrained to the surface 4, it is the frame 2 that is fed along the line of feed “A”, moving relative to the surface 4 as already indicated.

In this way, the cleaner 1 translates along the line of feed “A”.

Finally, the second gripping unit 8b is returned to the active configuration, re-establishing the starting configuration.

By following that procedure over and over, the cleaner 1 translates, being fed with separate steps, along the surface 4 along the line of feed “A”.

Obviously, since the cleaner 1 can move along two lines, that is to say, the two lines of feed, it can cover the entire surface 4 of the hull.

Preferably, the cleaner 1 comprises a transmitter 32, which can be used by an operator, and a receiver 33 which is connected to the frame and operatively associated with the transmitter 32.

The receiver 33 is functionally connected to the control unit 31 for receiving signals representing a command issued by the operator and sending said signals to the control unit 31.

Advantageously, in that way the cleaner can be remote-controlled.

For that purpose, the receiver 33 comprises a sonar 34 in such a way as to receive signals from the transmitter when it is under water.

The cleaner 1 may also be controlled manually or programmable in such a way as to be able to carry out underwater cleaning autonomously.

In that case, it comprises a programmable memory and suitable sensors (not illustrated) associated with the legs 11, 22 and designed to determine the limits within which the cleaner must move.

In other words, the sensors determine the presence or absence of the surface 4 to be cleaned at the suction cups 10, changing the line of feed at the moment when the surface is no longer detected.

In an alternative embodiment (not illustrated), the movement means do not translate the second gripping unit in the further line of feed “B”, but instead generate a relative rotation between the frame and the second gripping unit.

In that way, the cleaner is not limited to rigidly translating on the surface 4, but is capable of rototranslation, with the possibility of following many different paths.

In another alternative embodiment (not illustrated), the movement means act on the first gripping unit to also move it along the further line of feed “B”.

In other words, only the first gripping unit can move relative to the frame along the lines of feed.

Indeed, in that case, the second gripping unit would only be used for keeping the cleaner in contact with the hull during feeding of the first gripping unit along one of the guides.

The invention achieves the preset aims and brings important advantages.

The cleaner can simply be positioned on the underwater hull of the boat and moved along it to clean without dry-docking.

Moreover, the possibility of moving the cleaner along two axes facilitates and speeds up cleaning of the hull.

The possibility of lifting the legs off the surface during movement also makes cleaning easy even for uneven surfaces.

In addition, the possibility of remote controlling the cleaner, or even of having it operate autonomously, makes the invention easy to use.

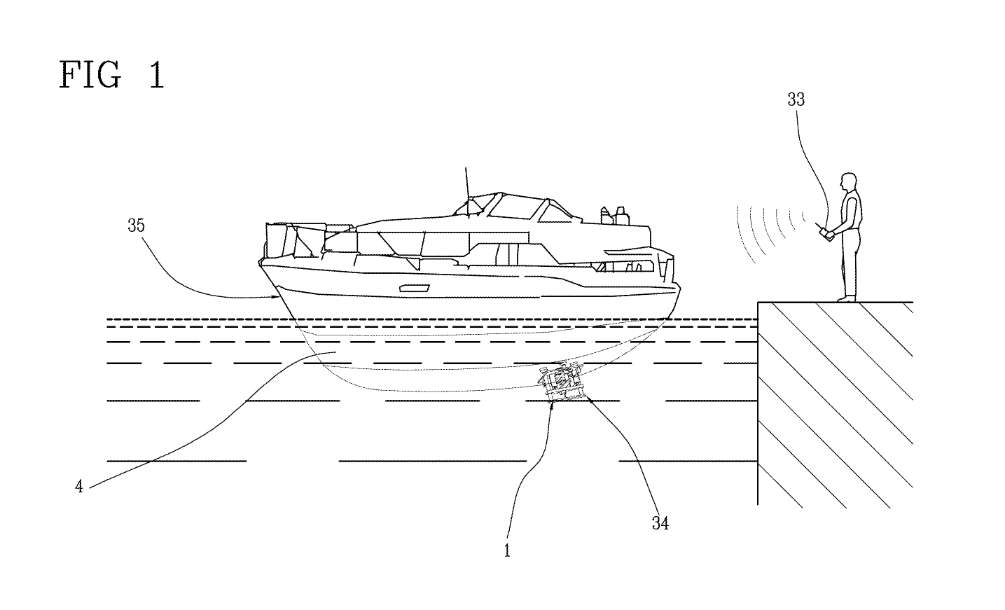

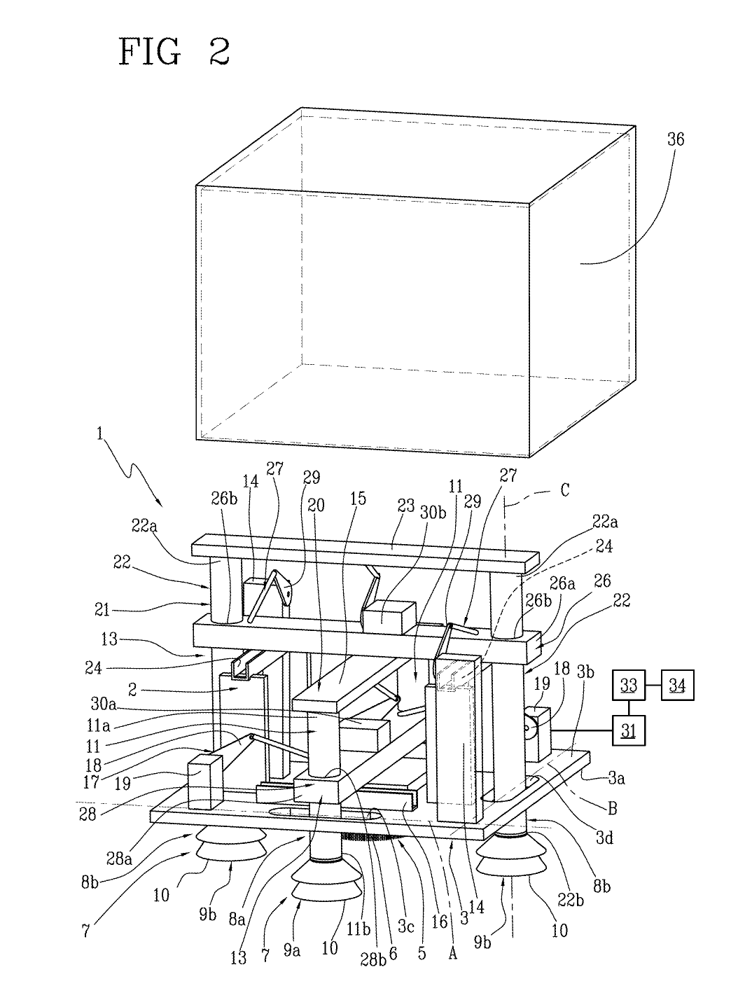

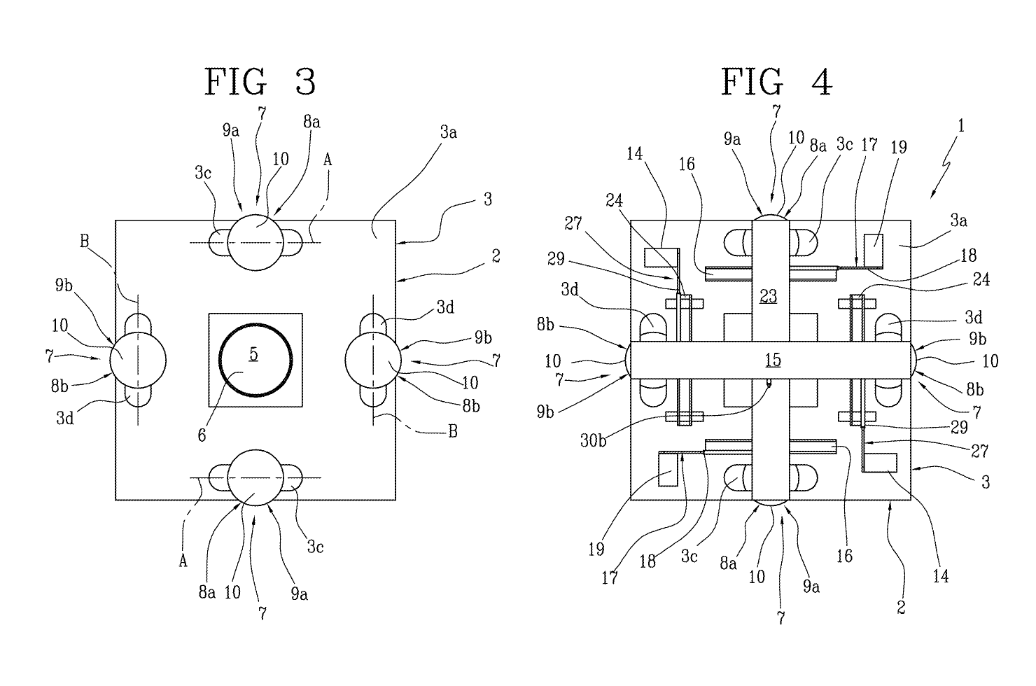

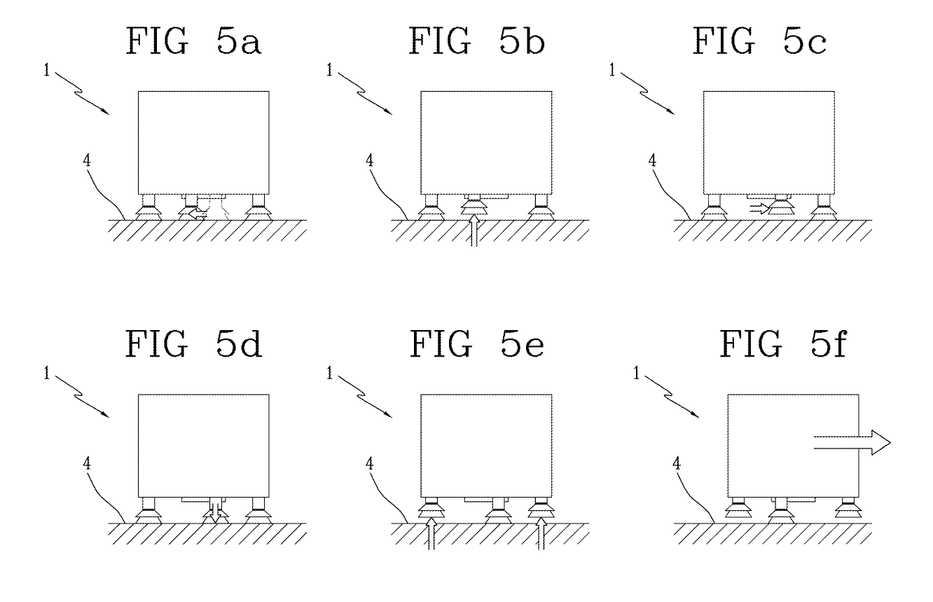

It should be noticed that the content of this invention should not be considered limited to the specific embodiment illustrated in FIGS. 1 to 5.

In fact, the cleaner may be made in various ways, in particular with reference to the configuration of the movement means and the method for activating them.

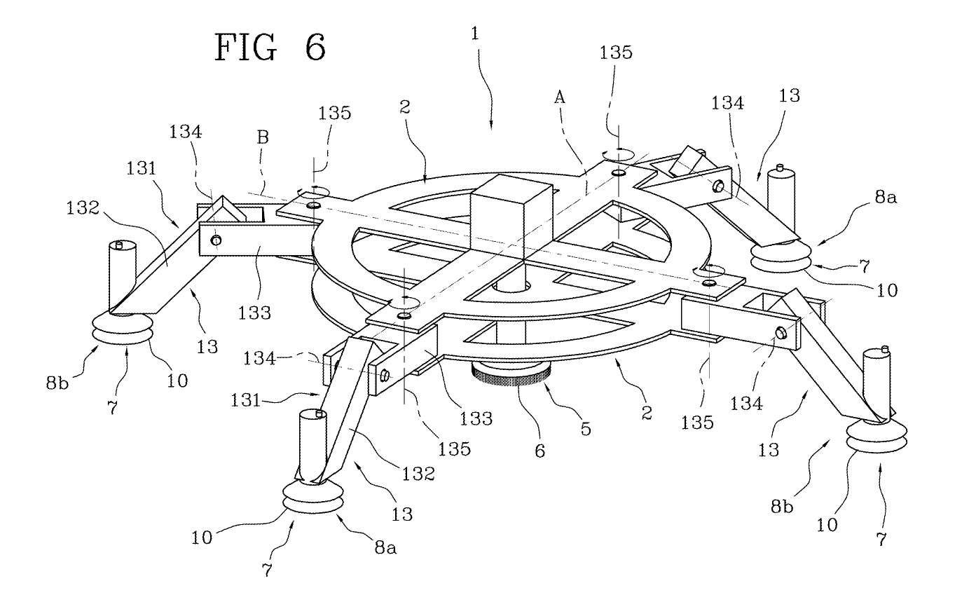

For example, a possible alternative embodiment is illustrated in FIG. 6.

In this case, the movement means comprise a plurality of articulated legs 131 (at least two, four in the example illustrated).

Each leg 131 comprises a first end connected to one of the hold-down units (that is to say, a gripping unit 8a, 8b, in the example illustrated a suction cup 10) and a second end connected to the frame 2.

In particular, each leg 131 has a first portion 132 (that is to say, a first element, preferably a rod-shaped element) and a second portion 133 (that is to say, a second element, preferably a rod-shaped element) pivoting at each other (that is to say, hinged to one another) in such a way that they can rotate one relative to the other about an axis 134.

In the embodiment illustrated (with reference to FIG. 6), the axis 134 is substantially parallel with the surface 4 to be cleaned.

The first portion 132 is associated with the hold-down unit, while the second portion 133 is associated with the frame 2. In particular, the second portion 133 comprises a first end pivoting at the first portion 132 and a second end pivoting at the frame 2 in such a way as to allow rotation about a further axis 135 which is operatively positioned perpendicular to the surface to be cleaned.

More precisely, the second portion 133 of each leg 131 comprises a first sub-part and a second sub-part which pivot at one another in such a way that they can rotate one relative to the other about an axis which is substantially parallel with the surface 4 to be cleaned (therefore parallel with the axis 134).

The first sub-part pivots at the frame 2 and the second sub-part pivots at the first portion 132 of the leg 131. In other words, the cleaner 1 can move like a spider.

Advantageously, in this way it is possible to vary the angle of the gripping units 8a, 8b (that is to say, of the suction cups 10), allowing cleaning of the surface 4 and feeding of the cleaner 1 even where there are sudden changes in gradient.

It should be noticed that the axis 134 of rotation between the two portions 132 and 133 of the leg is not parallel with the further axis 135 of rotation of the leg 131 relative to the frame 2. Preferably, the axis 134 of rotation is perpendicular to the further axis 135 of rotation. In particular, the axis 134 of rotation is positioned in such a way that each hold-down unit can be lowered and lifted relative to the surface to be cleaned.

There are drive units (preferably independent) for moving the first portions 132 of the legs 131 relative to the second portions 133 and drive units for moving the second portions 133 of the legs 131 relative to the frame 2.

The drive units are connected to a control unit programmed for operating the drive units according to a preset logic, in such a way as to control the movement of the cleaning robot according to a desired path (preset or determined by the user with a remote control).

The legs 131 are preferably connected to a perimetric zone of the frame 2. For example, the frame 2 has a circular shape. The cleaning brush 6 is preferably associated with a central zone of the frame 2.

In the alternative embodiment according to FIG. 6, the movement means only provide rotary movements. That makes the mechanical structure of the cleaning device particularly simple.

The cleaner may also be designed in such a way that the movement means provide a combination of rotary and translating movements.

What is claimed is:

1) A cleaner for the hulls of boats, comprising:
a supporting frame (2);
at least one cleaning element (5) associated with the frame (2) and which can be positioned opposite a surface (4) of the hull to be cleaned;
hold-down means (7) connected to the frame (2) and operatively active between the frame (2) and the surface (4) to be cleaned, for keeping the cleaner in contact with the surface (4) to be cleaned;
movement means (13) associated with the frame (2) for moving, in conjunction with the hold-down means (7), the frame (2) along the surface (4) to be cleaned,
wherein the movement means (13) comprise a plurality of articulated legs (131), each comprising a first portion (132) associated with a respective hold down unit (7) and a second portion (133) associated with the frame (2); the first and second portions (132, 133) pivoting at each other in such a way that they can rotate one relative to the other about an axis (134) positioned in such a way that each hold-down unit (7) can be lowered and raised relative to the surface (4) to be cleaned by means of said rotation.

2) The cleaner according to claim 1, wherein the second portion (133) comprises a first end pivoting at the first portion (132), in such a way as to allow rotation about the axis (134), and a second end pivoting at the frame (2) in such a way as to allow rotation about a further axis (135) which is operatively positioned perpendicular to the surface (4) to be cleaned.

3) The cleaner according to claim 1, wherein the movement means (13) comprise independent drive units for moving the first portions (132) of the legs (131) relative to the second portions (133) and for moving the second portions (133) of the legs (131) relative to the frame (2).

4) The cleaner according to claim 1, wherein the second portion (133) of each leg (131) comprises a first sub-part and a second sub-part pivoting at each other in such a way that they can rotate one relative to the other about an axis which is substantially parallel with the surface (4) to be cleaned; the first sub-part pivoting at the frame (2) and the second sub-part pivoting at the first portion (132) of the leg (131).

5) The cleaner according to claim 1, wherein the movement means (13) comprise at least four articulated legs (131) which are able to move independently of each other.

6) The cleaner according to claim 1, wherein the hold-down means (7) comprise a first gripping unit (8a) and a second gripping unit (8b), each gripping unit being associated with a respective leg (131) and being selectively switchable between an active configuration, in which it keeps the cleaner in contact with the surface (4) to be cleaned, and an inactive configuration.

7) The cleaner according to claim 6, wherein each gripping unit (8a, 8b) is movable towards and/or away from the surface (4) to be cleaned, between a contact position, in which it adheres to the surface (4), and a detached position, in which it is distal from the surface (4).

8) The cleaner according to claim 6, wherein the movement means (13) are operatively active between the frame (2) and the first gripping unit (8a), generating a relative movement along the line of feed (A) between the frame (2) and the first gripping unit (8a).

9) The cleaner according to claim 6, wherein each gripping unit (8a, 8b) comprises at least one suction device (9a, 9b) which can be selectively switched between an operating configuration, in which it generates a force attracting it to the surface (4) to be cleaned, and a non-operating configuration.

10) The cleaner according to claim 9, wherein each suction device (9a, 9b) comprises at least one suction cup (10) and a vacuum pump which is associated with the suction cup (10), there being the possibility of activating the vacuum pump when the suction cup (10) is in a position in contact with the surface (4) for defining the operating configuration of the suction device (9a, 9b).

11) The cleaner according to claim 1, comprising a control unit (31) associated with the hold-down means (7) and with the movement means (13) for defining a feed path for the frame (2) along the surface (4) to be cleaned.

12) The cleaner according to claim 11, comprising a transmitter (32) which can be used by an operator and a sonar forming a receiver (33) which is operatively coupled to the transmitter (32) and functionally connected to the control unit (31).

13) The cleaner according to claim 1, wherein the cleaning element (5) comprises at least one rotary brush (6).

14) A method for cleaning a hull of a boat or a ship, comprising the following steps:
preparing a device comprising a supporting frame (2), at least one cleaning element (5) associated with the frame (2) and which can be positioned opposite a surface (4) of the hull to be cleaned, hold-down means (7) which are connected to the frame (2), acting between the frame (2) and the surface (4) to be cleaned, keeping the cleaner in contact with the surface (4) to be cleaned and comprising a first gripping unit (8a) and a second gripping unit (8b) which can be switched between an active configuration, in which they keep the cleaner in contact with the surface (4) to be cleaned, and an inactive configuration, in which they are free to move relative to the surface to be cleaned and movement means (13) associated with the frame (2) for moving, in conjunction with the hold-down means (7), the frame (2) along the surface (4) to be cleaned and comprising a plurality of articulated legs (131);
associating the device with the surface to be cleaned by activating at least the first gripping unit (8a), thus allowing the cleaning element to clean a portion of the surface opposite it;
deactivating the second gripping unit (8b);
feeding said device by means of at least one step of lifting the second gripping unit (8a) for rotation of at least one portion of the respective leg (131) about an axis (134).

15) The method according to claim 14, wherein the feeding step comprises the sub-steps of:
lifting the second gripping unit (8b) by means of a rotation of the first portion (132) of the respective leg (131) about an axis (134);
moving the second gripping unit (8b) relative to the frame (2) along a line of feed (A) and in a predetermined direction, by means of a rotation of the respective leg (131) about a further axis (135) which is at a right angle to the surface (4) to be cleaned, while the first gripping unit (8a) is in the active configuration;
activating the second gripping unit (8b);
deactivating the first gripping unit (8a);
lifting the first gripping unit (8a) by means of a rotation of the first portion (132) of the respective leg (131) about the axis (134);
moving the first gripping unit (8a) and the frame (2) relative to the second gripping unit (8b) along the line of feed (A), in said predetermined direction, by means of a rotation of the leg (131) of the second gripping unit (8b) about the further axis (135), while the second gripping unit (8b) is in the active configuration;
repeating the previous steps, starting with deactivating the second gripping unit (8b), for moving the device along the line of feed (A).
